(19) United States
(12) Patent Application Publication
(10) Pub. No.: US 2024/0016335 A1
(43) Pub. Date: Jan. 18, 2024

(54) BEVERAGE MACHINE WITH LIQUID LEVEL MEASUREMENT

(71) Applicant: Keurig Green Mountain, Inc., Burlington, MA (US)

(72) Inventors: Blair Mikkelsen, Chicago, IL (US); Matthew Martin Kenneth Hansen, Cambridge, MA (US); Jianming Huang, Andover, MA (US)

(73) Assignee: Keurig Green Mountain, Inc., Burlington, MA (US)

(21) Appl. No.: 18/033,431

(22) PCT Filed: Oct. 26, 2021
(86) PCT No.: PCT/US2021/056645

§ 371 Date: Apr. 24, 2023

Related U.S. Application Data
(60) Provisional application No. 63/106,585, filed on Oct. 28, 2020.

(51) Int. Cl. A47J 31/54; A47J 31/56; A47J 31/46

(52) U.S. Cl. CPC A47J 31/545; A47J 31/56; A47J 31/468; A47J 31/461

(57) ABSTRACT

Methods and systems of determining the amount of liquid in a liquid supply tank of a beverage forming machine without a dedicated sensor are disclosed herein. In some embodiments, the beverage forming machine includes a controller capable of determining the amount of liquid in the liquid supply tank based on a gas volume in a reference vessel, such as a conduit, in fluid communication with the liquid supply tank.

### CROSS REFERENCE TO RELATED APPLICATION

This application claims priority to U.S. Application No. 63/106,585, filed Oct. 28, 2020, which is hereby incorporated by reference in its entirety.

### FIELD

This disclosure relates to beverage forming systems, such as coffee brewers that use a liquid to form a coffee beverage.

### BACKGROUND

To form a beverage, a beverage forming machine may require a threshold volume of a base liquid, such as water, which may be stored in a liquid supply tank. To determine whether a beverage forming machine has a sufficient volume of the base liquid to form a given beverage, a conventional beverage forming machine may include a dedicated sensor configured to detect the volume of the base liquid in the liquid supply tank. However, including a dedicated sensor to detect the volume of the base liquid in the liquid supply tank may increase the manufacturing costs of the beverage forming machine.

Beverage forming systems that use a liquid, such as water, to form a beverage are well known. For example, U.S. Pat. No. 10,034,571 discloses a beverage forming system that measures a volume of a liquid in a vessel based on the time required to empty a volume of liquid from a manometer column containing a ball and a sensor during a beverage forming process. U.S. Pat. No. 6,926,170 discloses a beverage forming system with a pump positioned above a water tank. The beverage forming system of U.S. Pat. No. 6,926,170 detects that the water tank is empty when a vacuum sensor positioned in a water line connected to the water tank detects a high vacuum when the pump operates.

### BRIEF SUMMARY

According to one embodiment, a beverage machine includes a liquid supply tank, a conduit, a pump, and a controller. The liquid supply tank is configured to hold a liquid for forming a beverage such that the liquid has a liquid level in the liquid supply tank. The conduit has an inlet fluidly coupled to the liquid supply tank, such that the conduit has a section containing a gas having a gas volume. The pump is fluidly coupled to an outlet of the conduit, and is configured to pump liquid and gas (e.g., from the conduit). The controller is configured to determine the liquid level in the liquid supply tank based on the gas volume in the conduit or based on an operation time of the pump required to pump the gas volume from the conduit.

According to another embodiment, a beverage machine includes a liquid supply tank, a conduit, a pump, and a controller. The liquid supply tank is configured to hold a liquid for forming a beverage such that the liquid has a liquid volume in the liquid supply tank. The conduit has an outlet and an inlet fluidly coupled to the liquid supply tank, and the conduit has a section extending from the outlet containing a gas. The pump has an inlet fluidly coupled to the outlet of the conduit, and the pump is configured to pump liquid and gas. The controller is configured to determine the liquid volume in the liquid supply tank based on a gas volume moved by the pump or based on an operation time of the pump required to draw the liquid to the pump inlet.

In some embodiments, the beverage machine includes a sensor configured to determine whether the pump is pumping liquid or gas.

In some embodiments, the controller is configured to determine the liquid level and/or the liquid volume in the liquid supply tank based on the gas volume in the conduit. In some embodiments, the controller is configured to determine the liquid volume in the liquid supply tank based on the gas volume moved by the pump to draw the liquid to the pump inlet at a start of a beverage cycle. The controller may also be configured to count pump cycles and/or measure the operation time of the pump during pump operation when the sensor determines that the pump is pumping gas and stop counting pump cycles and/or measuring the operation time of the pump when the sensor determines that the pump is pumping liquid. The controller may be further configured to determine the liquid level and/or the liquid volume in the liquid supply tank by comparing the counted number of pump cycles and/or the measured operation time of the pump to a table of known liquid level and/or liquid volume values. The controller may also be configured to determine a liquid volume in the liquid supply tank based on the liquid level in the liquid supply tank. Similarly, the controller may be configured to determine a liquid level in the liquid supply tank based on the liquid volume in the liquid supply tank.

In some embodiments, the beverage machine includes a vent configured to vent a portion of the conduit to atmospheric pressure. The vent and the conduit may be arranged such that when a portion of the conduit is vented to atmospheric pressure, a liquid level in the conduit is equal to the liquid level in the liquid supply tank. The vent may also include a valve configured to selectively open and close the vent. The controller may be configured to selectively open and close the valve.

According to another embodiment, a beverage machine includes liquid supply tank, a pump, a conduit, and a vent. The liquid supply tank is configured to hold a liquid for forming a beverage, and the liquid supply tank has a maximum capacity for holding the liquid. The liquid reaches a first height vertically above from a bottom of the liquid supply tank when the liquid supply tank is filled to the maximum capacity. The pump has an inlet and is configured to selectively pump the liquid towards an outlet. The pump is disposed at a second height vertically greater than the first height. The conduit is fluidly coupled between the liquid supply tank and the pump to supply liquid to the pump inlet. The vent is configured to vent a portion of the conduit to atmospheric pressure.

In some embodiments, the vent is disposed at a third height vertically greater than the second height.

In some embodiments, the conduit includes a portion that is oriented vertically.

According to another embodiment, a method of determining a volume of a liquid in a liquid supply tank of a beverage machine is disclosed. The method includes determining an initial volume of the liquid in the liquid supply tank at a start of a beverage cycle during which a first volume of the liquid is used to form a beverage. The method further includes determining a remaining volume of the liquid in the liquid supply tank based on the initial volume and the first volume and without measuring a volume of the liquid in the liquid supply tank after the start of the beverage cycle. The method also includes comparing the remaining volume of the liquid in the liquid supply tank to a threshold volume; and providing an indication that the remaining volume of the liquid in the liquid supply tank is lower than the threshold volume.

In some embodiments, determining the initial volume of liquid in the liquid supply tank at the start of the beverage cycle includes determining a gas volume in a conduit. Determining the gas volume in the conduit may include measuring an operation time and/or a number of pump cycles required for pumping the gas volume from the conduit.

In some embodiments, determining the remaining volume of the liquid in the liquid supply tank includes subtracting the first volume of the liquid used to form a beverage during the beverage cycle from the initial volume of liquid in the liquid supply tank.

In some embodiments, comparing the remaining volume of the liquid in the liquid supply tank to a threshold volume includes selecting a threshold volume based on a minimum volume of the liquid required for a beverage cycle.

According to another embodiment, a beverage machine includes a liquid supply tank and a controller. The liquid supply tank is configured to hold an initial volume of a liquid at a start of a beverage cycle during which a first volume of the liquid is used to form a beverage. The controller is configured to determine a remaining volume of the liquid in the liquid supply tank based on the initial volume and the first volume and without measuring a volume of the liquid in the liquid supply tank after the start of the beverage cycle. The controller is further configured to compare the remaining volume of the liquid in the liquid supply tank to the threshold volume and provide an indication that the remaining volume of the liquid in the liquid supply tank is lower than the threshold volume.

These and other aspects of the disclosure will be apparent from the following description and claims. It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a perspective view of a beverage forming machine in an illustrative embodiment;

FIG. 2 shows the functional components of a beverage forming machine in an illustrative embodiment; and

FIG. 3 is schematic diagram of functional components of the beverage forming machine in an illustrative embodiment.

### DETAILED DESCRIPTION

It should be understood that aspects of the disclosure are described herein with reference to certain illustrative embodiments and the figures. The illustrative embodiments described herein are not necessarily intended to show all aspects of the disclosure, but rather are used to describe a few illustrative embodiments. Thus, aspects of the disclosure are not intended to be construed narrowly in view of the illustrative embodiments. In addition, it should be understood that aspects of the disclosure may be used alone or in any suitable combination with other aspects of the disclosure.

Generally speaking, a beverage forming system may be used to form any suitable beverage, such as tea, coffee, other infusion-type beverages, beverages formed from a liquid or powdered concentrate, soups, juices or other beverages made from dried materials, carbonated or uncarbonated beverages. The beverage forming machine may form such beverages using a base liquid, such as water, stored in a liquid supply tank. A beverage forming system may be capable of forming a variety of beverages, each requiring a different amount of the base liquid. Thus, it may be desirable for a beverage forming machine to include features that allow the beverage forming machine to measure a liquid level or liquid volume in the liquid supply tank.

In some embodiments, a beverage forming system can be capable of determining the liquid level or liquid volume in the liquid supply tank without employing a dedicated sensor for actually measuring the level or volume of the liquid in the liquid supply tank. For example, in some embodiments, a beverage system can determine a level and/or volume of liquid in a supply tank based on a pump operation time and/or a gas volume pumped from a conduit required to remove gas from at least a portion of a supply line to a pump inlet. Based on the gas volume pumped from the conduit or pump operation time, the system can determine a level of liquid in the conduit, and thus a level and/or volume of liquid in the supply tank. This can allow the system to accurately determine the level and/or volume of liquid in the supply tank without use of a sensor that detects liquid level or volume in any specific way. However, in some embodiments such liquid level and/or volume measurement can be employed in a system that also includes a liquid level or volume sensor, e.g., as a back up to the liquid level sensor, to confirm accuracy of the liquid level sensor, to calibrate the liquid level sensor, to determine liquid levels and/or volumes above or below a measurement range of the sensor, etc.

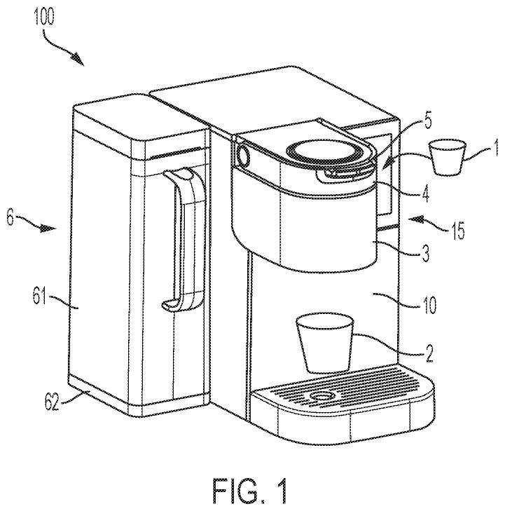

FIG. 1 shows a perspective view of a beverage forming system 100 that incorporates features of this disclosure. In this illustrative embodiment, the system 100 is arranged to form coffee or tea beverages. As is known in the art, a beverage cartridge 1 may be provided to the system 100 and used to form a beverage that is deposited into a user's cup or other suitable container 2. The cartridge 1 may be manually or automatically placed in a brew chamber 15 that includes a cartridge holder 3 and cover 4 of the beverage forming system 100. For example, the holder 3 may be or include a circular, cup-shaped or otherwise suitably shaped opening in which the cartridge 1 may be placed. With a cartridge 1 placed in the cartridge holder 3, a handle 5 may be moved by hand (e.g., downwardly) so as to move the cover 4 to a closed position (as shown in FIG. 1). In the closed position, the cover 4 at least partially covers the cartridge 1, which is at least partially enclosed in a space in which the cartridge is used to make a beverage. For example, with the cartridge 1 held by the cartridge holder 3 in the closed position, water or other liquid may be provided to the cartridge 1 (e.g., by injecting the liquid into the cartridge interior) to form a beverage that exits the cartridge 1 and is provided to a cup 2 or other container. Of course, aspects of the disclosure may be employed with any suitably arranged system 100, including drip-type coffee brewers, carbonated beverage machines, and other systems that deliver water or other liquid to form a beverage. Thus, a cartridge 1 need not necessarily be used, but instead the brew chamber may accept loose coffee grounds or other beverage material to make a beverage. Also, the brew chamber 15 need not necessarily include a cartridge holder 3 and a cover 4. For example, the brew chamber may include a filter basket that is accessible to provide beverage material (such as loose coffee grounds), and the filter basket itself may be movable, e.g., by sliding engagement with the beverage machine 10 housing, and a cover 4 may be fixed in place. In other embodiments, the brew chamber need not be user accessible, but instead beverage material may be automatically provided to, and removed from, the brew chamber. Moreover, the system 100 need not have a brew chamber 15, but instead other types of dispensing stations, e.g., that dispense hot and/or cold water (whether still or carbonated) at an outlet such as a dispensing nozzle without mixing with any beverage ingredient. Accordingly, a wide variety of different types and configurations for a dispensing station may be employed with aspects of this disclosure.

In some embodiments, a beverage forming machine includes features that allow the beverage forming machine to determine the liquid level and/or volume in the liquid supply tank based on a gas volume downstream of the liquid supply tank, for example in a conduit configured to hold both a liquid and a gas. The beverage forming machine may also include a pump configured to pump both the liquid and the gas from the conduit downstream towards an outlet. The beverage forming machine may also include a sensor capable of detecting whether the pump is pumping gas or liquid or otherwise indicate that a gas volume has been removed from the conduit. An operation time of the pump or a number of pump cycles until the gas volume has been removed from the conduit, e.g., when the pump begins pumping liquid, can be used to determine the liquid level and/or liquid volume in the liquid supply tank.

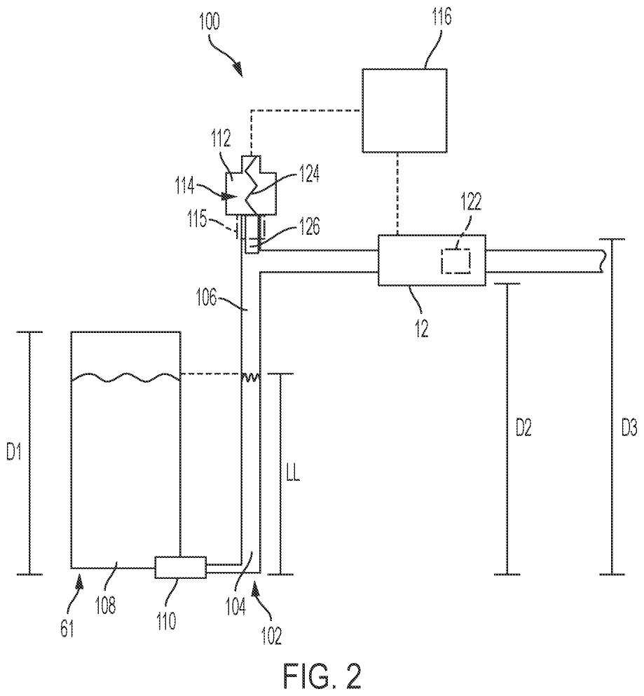

For example, FIG. 2 shows the functional components of a beverage forming machine 100 that incorporates features allowing a controller 116 to determine a liquid level LL, a gas volume 106 and/or a liquid volume 104 in a conduit 102. At an initial point, such as at the start of a beverage cycle, conduit 102 contains a liquid volume 104 and a gas volume 106. Gas volume 106 may be positioned downstream of liquid volume 104, and an interface where the gas and liquid volumes 106, 104 meet is the liquid level LL. When pump 12 initially operates, pump 12 first pumps gas from the gas volume 106 until gas is removed from the conduit 102 and then pumps liquid from the liquid volume 104. As described more below, the controller 116 can exploit the feature that the pump 12 initially pumps gas, and then pumps liquid to determine the gas volume 106 and/or the liquid level LL. Conduit 102 may also be configured to hold a known total volume. Accordingly, beverage forming system 100 may measure liquid volume 104 by subtracting gas volume 106 from the total known volume of the conduit.

To determine the gas volume 106 and/or liquid level LL, beverage forming system 100 may count the number of pump cycles required to push the gas volume 106 out of conduit 102, a time period required to pump the gas volume 106 out of conduit 102, or other suitable metric. For example, the pump 12 may be arranged to pump a particular volume of fluid (liquid or gas) for each pump operation cycle and/or for a particular operation time. By determining a number of pump cycles or operation time to pump gas from the conduit 102, the controller 116 can determine the gas volume 106 and/or the liquid level LL. A sensor 122 may be arranged to detect pump characteristics, whether the pump is pumping liquid or gas, and/or the arrival of liquid at a point in the conduit 102. For example, the sensor 122 can be configured as an infrared sensor or any other suitable sensor to detect pump operation cycles, e.g., revolutions of a pump shaft, cycles of a piston or other pump component, etc. In some embodiments, the sensor 122 can detect pump voltage and/or current, and based on the measured voltage and/or current, determine when liquid arrives at the pump. As an example, the current draw by the pump 12 may change when liquid arrives at the pump, e.g., the current draw may increase when the pump 12 transitions from pumping gas to pumping water. The controller 116 can use this change in voltage and/or current to detect when liquid arrives at the pump 12, and thus when the gas volume 106 has been removed from the conduit 102. In some embodiments, the sensor 122 can be a conductive, capacitive, optical or other sensor that detects when liquid arrives at the pump or at some other location in the conduit 102, e.g., upstream of the pump 12. Note that the sensor 122 can detect two or more characteristics of the system, such as pump cycles and the presence of liquid at a point in the conduit 102, and may use two or more distinct sensor components to do so, e.g., an infrared sensor to detect pump shaft revolutions and a conductive probe to detect liquid in the conduit 102. Sensor 122 may be in electronic communication with the controller 116 which can use information (e.g., one or more signals) from the sensor 122 to determine the volume of gas 106 in the conduit 102, a liquid level LL or other features of the system.

In some embodiments, the controller 116 can determine the gas volume 106 and/or liquid level LL at the start of a beverage cycle. At the start of a beverage cycle, the controller 116 can activate the pump 12, which begins to pump gas volume 106 out of conduit 102. Once the pump 12 has begun to pump gas volume 106, the controller 116 can begin collecting suitable data from the sensor 122 regarding the operation of pump 12 and/or arrival of liquid. Suitable data may include a count of a number of pump cycles, an operation time of pump 12, an instantaneous flow rate of fluid through pump 12, an average flow rate of fluid through pump 12, or any other suitable metric.

Once sensor 122 detects that the gas volume 106 has been removed from the conduit 102, for example, when a portion of liquid volume 104 reaches a point in the conduit 102 upstream of or at the pump 12, the controller 116 can use the collected data to determine the gas volume 106 and/or liquid level LL. As an example, the controller 116 may compare data regarding the operation of pump 12 (e.g., number of pump cycles, an operation time of pump 12, an instantaneous flow rate of fluid through pump 12, and/or an average flow rate of fluid through pump 12) to a lookup table of known gas volumes and corresponding data regarding operation of pump 12, such as pump cycles or operation time. (If the table of known gas volumes does not include an exact match for the data regarding the operation of pump 12, controller 116 may interpolate gas volume 106 between two data points on the table surrounding the data regarding the operation of pump 12 or select one of the nearest values.) Alternately, the controller 116 can use an algorithm that employs the data regarding pump operation (e.g., pump cycles, operation time, etc.) as an input to determine the gas volume 106. Thus, controller 116 may determine gas volume 106, which need not be an entire volume of gas in the conduit 102, but rather only a portion of the entire volume of gas, e.g., where the sensor 122 detects the presence of liquid upstream of the pump 12.

Once controller 116 determines the gas volume 106, controller 116 may compare the gas volume 106 to gas volume values in a lookup table of gas volumes and corresponding known liquid levels LL. (If the table of known liquid levels does not include an exact match for liquid level LL the controller 116 may interpolate the liquid level LL between two data points on the table or select a nearest value.) Alternately, the controller 116 can use an algorithm that employs the gas volume 106 as an input to determine the liquid level LL. Thus, controller 116 may determine a liquid level in the conduit LL.

Alternatively or in addition, the controller 116 may determine the liquid volume 104 in conduit 102 by subtracting the determined gas volume 106 from a known total volume of conduit 102. Controller 116 may also know the dimensions of conduit 102. Thus, controller 116 may determine a liquid level LL in the conduit 102 by comparing the liquid volume 104 to the dimensions of conduit 102. For example, in embodiments where conduit 102 is a vertically oriented cylinder, controller 116 determines liquid level LL by dividing liquid volume 104 by the cross sectional area of conduit.

In some embodiments, the controller 116 can determine the liquid level LL directly from pump operation information, such as pump cycles and/or pump operation time required to pump the gas volume 106 from the conduit 102. As an example, the controller 116 may store a lookup table of liquid level LL values and corresponding pump cycles or pump operation times required to pump gas from the conduit 102. To determine the liquid level LL in any particular case, the controller 116 can identify the pump cycles or operation time in the lookup table to determine the corresponding liquid level LL. Alternately, the controller 116 can use an algorithm or other technique to determine the liquid level LL.

In some embodiments, beverage forming machine 100 may include features that allow controller 116 to determine the liquid level and/or liquid volume in liquid supply tank 61 based on liquid level LL in the conduit. For example, conduit 102 may be configured to include a vent 115 configured to vent at least a portion of conduit 102 to the atmosphere. Vent 115 may be configured such that when vent 115 vents at least a portion of conduit 102 to the atmosphere, the liquid level LL in conduit 102 and the liquid level in liquid supply tank 61 are equal. For example, the liquid level LL in conduit 102 and the liquid level in liquid supply tank 61 are at a same level represented by LL in the embodiment of FIG. 2. As a result, if the controller 116 determines the gas volume 106 or liquid level LL for the conduit 102, the controller 116 can determine a liquid level and/or liquid volume in the tank 61 as well.

In some embodiments, vent 115 includes a valve 112. Valve 112 may selectively open and close vent 115, thus selectively controlling whether conduit 102 is open to the atmosphere. Vent 115 and valve 112 may be configured such that when valve 112 is open and pump 12 is active, pump 12 only pumps gas. Conversely, when valve 112 is closed, pump 12 will first pump gas volume 106 from conduit 102, then pump liquid volume 104 from conduit 102. In some embodiments, during the start of a beverage cycle, controller 116 closes valve 112. As will be appreciated by one of skill in the art, valve 115 need not be controlled by controller 116. For example, valve 112 may be manually operated. Alternatively, the operation of valve 115 may be tied to some other function of beverage forming machine 100, such as opening or closing cover 4 or operation of the pump 12 (e.g., the valve 112 can be open when the pump 12 is off and closed when the pump 12 is on). Valve 112 may also be operated by any other suitable means.

Valve 112 may be configured to include a solenoid 114 (as shown in FIG. 2). As will be appreciated from the above, valve 112 may be operated by controller 116. Controller 116 may operate valve 112 by manipulating a coil 124 to move a plunger 126. Specifically, controller 116 may operate the valve by energizing coil 124. In some embodiments, valve 112 may be in a “normally open” configuration. In the “normally open” configuration, plunger 126 is initially in a position such that conduit 102 is in fluid communication with the atmosphere via valve 115. Controller 116 may then selectively energize coil 124 to move plunger 126 such that plunger 126 blocks fluid communication between conduit 102 and the atmosphere. Specifically, controller 116 may energize coil 124 to close fluid communication between conduit 102 and the atmosphere at the start of, and during, a beverage cycle.

Of course, other configurations of solenoid 114 of valve 112 are also contemplated. For example, valve 112 may be configured in a “normally closed” configuration, wherein plunger 126 blocks fluid communication between conduit 102 and the atmosphere when coil 124 is not energized. It follows that in such a configuration, coil 124 will move plunger 126 into a position such that conduit 102 is in fluid communication with the atmosphere. As will be appreciated by one of skill in the art, valve 115 need not be configured as a solenoid valve. Alternatively, valve 112 may be configured as a ball valve, a gate valve, a butterfly valve, a diaphragm valve, or any other suitable valve.

It should be appreciated that a suitable beverage forming machine need not include a valve for a vent. For example, the beverage forming machine may be configured with a vent of sufficiently small size relative to the pump capacity such that the pump may overpower the vent when active, drawing first a gas volume then a liquid volume from a conduit, even when the conduit is open to the atmosphere. For example, in some embodiments, the vent 115 can include a permanently open orifice. The pump 12 and the orifice can be arranged so that the pump 12 can draw water to the pump 12 inlet even though the orifice is open to draw air into the conduit 102. The controller 116 can be arranged to determine the gas volume and/or liquid level LL by compensating for any gas that the orifice may introduce into the conduit 102 during pump operation, e.g., the orifice may introduce air at a constant flow rate during pump operation and the controller 116 can compensate for this volume of air introduced by the vent 115.

In some embodiments, the controller 116 may determine the liquid level and/or volume in liquid supply tank 61 directly, based on gas volume 106. For example, controller 116 may compare the measured gas volume 106 to a table of known liquid levels in liquid supply tank 61 and corresponding gas volume values. If the table does not include an exact match for the measured gas volume 106, controller 116 may interpolate the liquid level between two gas volumes on the table or select a nearest value. Thus, controller 116 may determine the liquid level and/or volume in liquid supply tank 61 based on gas volume 106 directly. Of course, the controller 116 can determine the supply tank 61 liquid level and/or volume directly based on pump operation characteristics such as pump cycles or operation time to remove a gas volume 106 from the conduit 102.

In some embodiments, beverage forming machine 100 includes features that allow that pump 12 to pump gas volume 106 before pumping liquid volume 104, thus allowing controller 116 to a gas volume 106 or liquid level LL for the conduit 102. For example, beverage forming machine 100 may ensure a correct computation of gas volume 106 or liquid level LL when pump 12 is positioned above the maximum fill level of liquid supply tank 61. As shown in the embodiment of FIG. 2, liquid supply tank 61 has a maximum fill level positioned at a first height D1 vertically above from a bottom of liquid supply tank 61. Further, pump 12 is positioned at a second height D2 vertically above from a bottom of liquid supply tank 61. In the embodiment of FIG. 2, height D2 is greater than height Dl.

As will be appreciated from the above, the configuration of conduit 102 and vent 115 allow the liquid level LL in conduit 102 to equal the liquid level in liquid supply tank 61. When LL equals D1, meaning that liquid supply tank 61 is filled to its maximum capacity, conduit 102 has a capacity between D2 and D1 where gas volume 106 may reside. Accordingly, in a configuration in which D2 is greater than D1, gas volume 106 will remain downstream of liquid volume 104. Thus, in such embodiments, pump 12 will always pump gas volume 106 before pumping liquid volume 104, allowing controller 116 to determine the gas volume 106, liquid volume 104, liquid level LL and/or liquid volume 108 according to the above described methodology.

In some embodiments, vent 115 may be positioned at a height D3 vertically above from a bottom of liquid supply tank 61. In some embodiments, height D3 is greater than the height D2 of pump 12 relative to the bottom of liquid supply tank 61. Thus, when valve 112 is open, a gas, such as air, may flow into beverage forming system 100 unobstructed via vent 115.

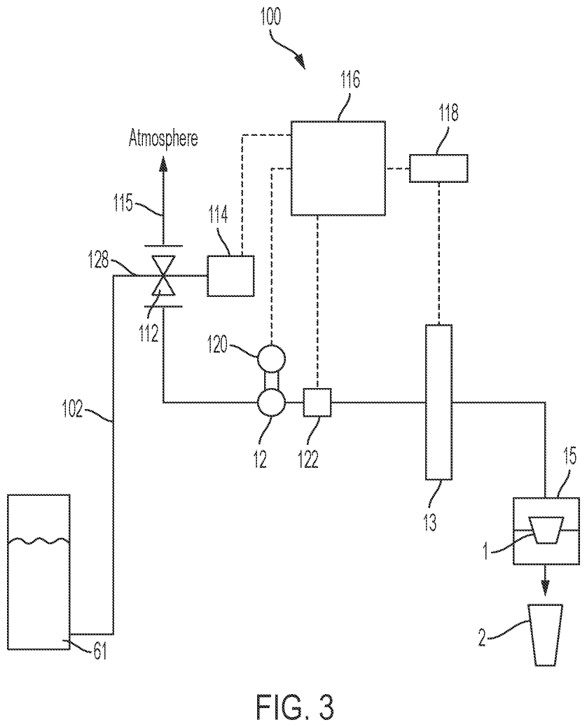

FIG. 3 is schematic diagram of functional components of beverage forming system 100 in an illustrative embodiment. In this embodiment, liquid supply tank 61 is fluidly coupled to conduit 102. Conduit 102 is fluidly coupled to both vent 115 and pump 12 via a T-connection 128. Vent 115 allows conduit 102 to be in fluid communication with the atmosphere. Valve 112 may selectively open and close vent 115 so as to selectively open and close fluid communication between conduit 102 and the atmosphere. Solenoid 114 opens and closes valve 112 when controller 116 instructs it to do so. When beverage forming machine 100 is idle, valve 112 remains open. In the embodiment of FIG. 3, in accordance with the previously described embodiments, initially the liquid level in liquid supply tank 61 is the same as the liquid level in the conduit 102.

To initiate a beverage cycle, a user may first insert a cartridge 1 into brew chamber 15 and provide an indication (e.g., by pressing a button or other suitable step) to beverage forming machine 100 to prepare a beverage. Controller 116 of beverage forming machine 100 then closes valve 112, by energizing coil 124 of solenoid 114. After valve 112 closes, controller 116 activates pump 12 by energizing a pump actuator 120, for example a pump motor, or other suitable pump actuator. Pump 12 is also equipped with a sensor 122 which detects whether pump 12 is pumping a gas or a liquid. Sensor 122 electronically communicates with controller 116. In this embodiment, the controller 116 begins tracking an operation parameter of the pump, such as operation time, pump cycles, gas flowrate, and/or other suitable parameter based on information from the sensor 122. Once sensor 122 detects that pump 12 is pumping liquid rather than gas (or otherwise indicates that a gas volume in the conduit 102 has been pumped out), sensor 122 indicates to controller 116 that pump 12 is no longer pumping gas, and controller 116 can determine a gas volume in the conduit 102, a liquid level in the conduit or tank 61 or a liquid volume in the tank 61 based on an operation parameter of the pump, such as operation time, pump cycles, gas flowrate, and/or other suitable parameter. Pump 12 then pumps liquid through beverage forming machine 100. Downstream of the pump, the liquid comes into contact with a heater 13 (e.g., a spiral heater, radiant heater, convection heater, or other suitable type of heater) configured to heat the liquid. The heated liquid then flows into brew chamber 15, which is holding cartridge 1. The heated liquid then mixes with the contents of cartridge 1 to form the beverage, which is subsequently dispensed into container 2. Once beverage forming machine 100 completes the beverage cycle and dispenses the beverage into container 2, controller 116 reopens valve 115, allowing pump 12 to pump gas (e.g., air) through beverage forming machine 100. Pumping gas through beverage forming machine 100 following a beverage cycle serves to evacuate water from beverage forming machine 100, e.g., to purge the heater 13 and cartridge 1 of any remaining amount of liquid.

In the illustrative embodiment if FIG. 3, pump 12 is a positive displacement pump, however, other pump configurations are also contemplated. For example, pump 12 may be configured as a centrifugal pump, a solenoid pump, a diaphragm pump, or any other suitable type of pump. Also in this illustrative embodiment, a power supply 118 provides power to both controller 116 and heater 13. Controller 116, which is in electronic communication with both power supply unit 118 and solenoid 114 may relay electrical power from power supply unit 118 to solenoid 114, for example, to energize coil 124. In other embodiments, however, power supply 118 may be in direct electrical communication with solenoid 114. In such embodiments, controller 116 directs power supply unit 118 to energize coil 124 of solenoid 114.

In some embodiments, beverage forming machine 100 includes features that enable controller 116 to provide an indication to a user of beverage forming machine 100 that the liquid volume 108 in liquid supply tank 61 is insufficient to form a beverage. In some embodiments, a beverage forming machine is configured to form a variety of beverages, such as an espresso, a latte, a cappuccino, or other suitable beverage. Each such beverage requires a known quantity of liquid to form, wherein the liquid is held in liquid supply tank 61. For example, an espresso may require 2 ounces of liquid to form while a latte may require 6 ounces of liquid. Of course, other beverages may require other amounts of liquid including fewer than 2 ounces of liquid, greater than 6 ounces of liquid, and between 2 and 6 ounces of liquid.

When controller 116 of beverage forming machine 100 determines the liquid level and/or liquid volume 108 of liquid supply tank 61 at the start of a beverage cycle, controller 116 may compare the liquid level in liquid supply tank 61 and/or liquid volume 108 to a known threshold liquid level and/or volume required to form the desired beverage. If the liquid level and/or liquid volume 108 is below the known threshold liquid level and/or volume required to form the desired beverage, controller 116 will end the beverage cycle prematurely, without forming the beverage. If the liquid level and/or liquid volume 108 is above the known threshold liquid level and/or volume required to form the desired beverage, beverage forming machine 100 will proceed with forming the desired beverage. For example, if liquid supply tank 61 initially contains 4 ounces of liquid, and a user instructs beverage forming machine 100 to form a latte, which requires 6 ounces of liquid, controller 116 will prematurely end the beverage cycle, and beverage forming machine 100 will not form the latte. However, if liquid supply tank 61 contains 4 ounces of liquid, and a user instructs beverage forming machine 100 to form an espresso, which requires 2 ounces of liquid, beverage forming machine 100 will proceed with forming the espresso. It should be appreciated that controller 116 may determine the liquid level and/or liquid volume 108 of liquid supply tank 61 at the start of a beverage cycle based on gas volume 106 and/or liquid level LL, in accordance with the previously discussed embodiments.

When controller 116 prematurely ends a beverage cycle, beverage machine 100 may provide the user with an indication that controller 116 prematurely ended the beverage cycle. For example, beverage forming machine 100 may include a light, which flashes when controller 116 prematurely ends a beverage cycle. Beverage forming machine 100, may also include a display informing the user that liquid supply tank 61 does not contain sufficient liquid to form the desired beverage and/or that liquid should be provided to the tank 61. Alternatively, beverage forming machine 100 may include a speaker configured to provide an auditory indication when controller 116 prematurely ends a beverage cycle. Of course, beverage forming machine 100 need not provide a light or auditory indication that controller 116 prematurely ended a beverage cycle. Of course, other suitable indications are also contemplated.

In some embodiments, beverage forming machine 100 includes features that enable controller 116 to provide an indication to a user of beverage machine 100 that the liquid volume in liquid supply tank 61 is insufficient to form any additional beverages following a beverage cycle. For example, controller 116 may first determine an initial volume of liquid in liquid supply tank 61 at the start of a beverage cycle as described in the embodiments above, by determining a gas volume in a conduit (i.e., by measuring the operation time or number of pump cycles required for pump 12 to pump gas volume 106 from conduit 102). Then, controller 116 may determine the remaining volume of the liquid in the liquid supply tank by computing a difference between a known volume of liquid used to form a beverage and the initial volume of liquid in liquid supply tank 61, as calculated by controller 116. Then, controller 116 may compare the remaining volume to a threshold smallest known volume of liquid required for beverage forming machine 100 to form a beverage. If the remaining volume is less than the threshold volume, controller 116 may provide an indication to the user that the remaining volume in liquid supply tank 61 is insufficient to form any possible beverage.

For example, a beverage forming machine may be capable of forming a beverage no smaller than an espresso, which requires 2 ounces of liquid. If liquid supply tank 61 initially contains 7 ounces of liquid, and a user employs beverage forming machine 100 to form a latte, which requires 6 ounces of liquid, controller 116 may employ the methods described above to calculate that the remaining liquid in liquid supply tank 61 is 1 ounce. Since 1 ounce is less than the 2 ounces of liquid required to form the smallest possible beverage, an espresso, controller 116 may provide an indication to the user that liquid supply tank 61 no longer holds sufficient liquid to form any possible beverage. When controller 116 provides an indication that beverage forming machine 100 may no longer form any additional beverages, controller 116 may provide one or more of a number of suitable indications. For example, beverage forming machine 100 may include a light, which flashes when beverage forming machine 100 may no longer form any additional beverages. Beverage forming machine 100, may also include a display informing the user that liquid supply tank 61 does not contain sufficient liquid to form any additional beverages. Alternatively, beverage forming machine 100 may include a speaker configured to provide an auditory indication when beverage forming machine 100 may no longer form any additional beverages. Of course, beverage forming machine 100 need not provide a light or auditory indication that beverage forming machine 100 may no longer form any additional beverages, as other suitable indications are also contemplated. Thus, the user may then take an appropriate action, such as refilling the tank.

In some embodiments, liquid supply tank 61 may include features that allow a user to easily refill liquid supply tank 61. In some embodiments, liquid supply tank is detachable from beverage forming machine 100. As shown in FIG. 2, liquid supply tank 61 may be removably coupled to a port receiver 110. Thus, a user may detach liquid supply tank 61 from port receiver 110, refill liquid supply tank 61 with a suitable liquid (e.g., water), and reattach liquid supply tank 61 to port receiver 110.

In some embodiments, port receiver 110 includes a check valve to prevent backflow into liquid supply tank 61, for example, to prevent contamination of the liquid in liquid supply tank 61. The check valve of port receiver 110 may prevent such backflow when controller 116 prematurely ends a beverage cycle, as described above, among other suitable circumstances.

While aspects of the disclosure may be used with any suitable cartridge, or no cartridge at all, some cartridges may include features that enhance the operation of a beverage forming system 100. As is known in the art, the cartridge 1 may take any suitable form such as those commonly known as a sachet, pod, capsule, container or other. For example, the cartridge 1 may include an impermeable outer covering within which is housed a beverage medium, such as roasted and ground coffee or other. The cartridge 1 may also include a filter so that a beverage formed by interaction of the liquid with the beverage medium passes through the filter before being dispensed into a container 2. As will be understood by those of skill in the art, cartridges in the form of a pod having opposed layers of permeable filter paper encapsulating a beverage material may use the outer portion of the cartridge 1 to filter the beverage formed. The cartridge 1 in this example may be used in a beverage machine to form any suitable beverage such as tea, coffee, other infusion-type beverages, beverages formed from a liquid or powdered concentrate, etc. Thus, the cartridge 1 may contain any suitable beverage material, e.g., ground coffee, tea leaves, dry herbal tea, powdered beverage concentrate, dried fruit extract or powder, powdered or liquid concentrated bouillon or other soup, powdered or liquid medicinal materials (such as powdered vitamins, drugs or other pharmaceuticals, nutriaceuticals, etc.), and/or other beverage-making material (such as powdered milk or other creamers, sweeteners, thickeners, flavorings, and so on). In one illustrative embodiment, the cartridge 1 contains a beverage material that is configured for use with a machine that forms coffee and/or tea beverages, however, aspects of the disclosure are not limited in this respect.

Also, the disclosure may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

As used herein, “beverage” refers to a liquid substance intended for drinking that is formed when a liquid interacts with a beverage material, or a liquid that is dispensed without interacting with a beverage material. Thus, beverage refers to a liquid that is ready for consumption, e.g., is dispensed into a cup and ready for drinking, as well as a liquid that will undergo other processes or treatments, such as filtering or the addition of flavorings, creamer, sweeteners, another beverage, etc., before being consumed.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this disclosure, it is to be appreciated various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

1. A beverage machine comprising:
a liquid supply tank configured to hold a liquid for forming a beverage, the liquid having a liquid level in the liquid supply tank;
a conduit having an inlet fluidly coupled to the liquid supply tank, the conduit having a section containing a gas having a gas volume;
a pump fluidly coupled to an outlet of the conduit, wherein the pump is configured to pump liquid and gas; and
a controller configured to determine the liquid level in the liquid supply tank based on the gas volume in the conduit or based on an operation time of the pump required to pump the gas volume from the conduit.

2. The beverage machine of claim 1, wherein the controller is configured to determine the liquid level in the liquid supply tank based on the gas volume in the conduit.

3. The beverage machine of claim 2, wherein the controller is configured to determine the gas volume in the conduit at a start of a beverage cycle based on a number of pump cycles required to pump the gas volume out of the conduit.

4. The beverage machine of claim 3, wherein the beverage machine includes a sensor configured to determine whether the pump is pumping liquid or gas.

5. The beverage machine of claim 4, wherein the controller is configured to count pump cycles during pump operation when the sensor determines that the pump is pumping gas and stop counting pump cycles when the sensor determines that the pump is pumping liquid.

6. The beverage machine of claim 5, wherein the controller is configured to determine the liquid level in the liquid supply tank by comparing the counted number of pump cycles required to pump the gas volume out of the conduit to a table of known liquid level values and corresponding pump cycles.

7. The beverage machine of claim 1, wherein the controller is configured to determine the liquid level in the liquid supply tank based on the operation time of the pump required to pump the gas volume from the conduit.

8. The beverage machine of claim 7, wherein the beverage machine includes a sensor configured to determine whether the pump is pumping liquid or gas.

9. The beverage machine of claim 8, wherein the controller is configured to measure the operation time of the pump when the sensor determines that the pump is pumping gas and to stop measuring the operation time of the pump when the sensor determines that the pump is pumping liquid.

10. The beverage machine of claim 9, wherein the controller is configured to determine the liquid level in the liquid supply tank by comparing the operation time of the pump to a table of known liquid level values and corresponding operation times.

11. The beverage machine of claim 1, further including a vent configured to vent a portion of the conduit to atmospheric pressure.

12. The beverage machine of claim 11, wherein the vent and the conduit are arranged such that when the portion of the conduit is vented to atmospheric pressure, a liquid level in the conduit is equal to the liquid level in the liquid supply tank.

13. The beverage machine of claim 11, wherein the vent includes a valve configured to selectively open and close the vent.

14. The beverage machine of claim 13, wherein the controller is configured to selectively open and close the valve.

15. The beverage machine of claim 1, wherein the pump is positioned at a height above a maximum liquid level of the liquid supply tank.

16. The beverage machine of claim 1, wherein the controller is configured to determine a liquid volume in the liquid supply tank based on the liquid level in the liquid supply tank.

17. A beverage machine comprising:
a liquid supply tank configured to hold a liquid for forming a beverage, the liquid having a liquid volume in the liquid supply tank;
a conduit having an outlet and an inlet fluidly coupled to the liquid supply tank, the conduit having a section extending from the outlet containing a gas;
a pump having an inlet fluidly coupled to the outlet of the conduit, wherein the pump is configured to pump liquid and gas; and
a controller configured to determine the liquid volume in the liquid supply tank based on a gas volume moved by the pump or based on an operation time of the pump required to draw the liquid to the pump inlet.

18. The beverage machine of claim 17, wherein the controller is configured to determine the liquid volume in the liquid supply tank based on the gas volume moved by the pump to draw the liquid to the pump inlet at a start of a beverage cycle.

19. The beverage machine of claim 18, wherein the controller is configured to determine the gas volume based on a number of pump cycles required to pump the gas volume out of the conduit.

20. The beverage machine of claim 17, wherein the controller determines the liquid volume in the liquid supply tank based on the operation time of the pump required to pump draw the liquid to the pump inlet at a start of a beverage cycle.

21. The beverage machine of claim 20, wherein the beverage machine includes a sensor configured to determine whether the pump is pumping liquid or gas.

22. The beverage machine of claim 17, further including a vent configured to vent a portion of the conduit to atmospheric pressure.

23. The beverage machine of claim 22, wherein the vent includes a valve configured to selectively open and close the vent.

24. The beverage machine of claim 23, wherein the controller is configured to selectively open and close the valve.

25. The beverage machine of claim 17, wherein the pump is positioned at a height above a maximum liquid level of the liquid supply tank.

26. A beverage machine comprising:
a liquid supply tank configured to hold a liquid for forming a beverage, the liquid supply tank having a maximum capacity for holding the liquid, wherein the liquid reaches a first height vertically above from a bottom of the liquid supply tank when the liquid supply tank is filled to the maximum capacity;
a pump having an inlet and configured to selectively pump the liquid towards an outlet, wherein the pump is disposed at a second height vertically greater than the first height;
a conduit fluidly coupled between the liquid supply tank and the pump to supply liquid to the pump inlet; and
a vent configured to vent a portion of the conduit to atmospheric pressure.

27-30. (canceled)

31. A method of determining a volume of a liquid in a liquid supply tank of a beverage machine, comprising:
determining an initial volume of liquid in the liquid supply tank at a start of a beverage cycle during which a first volume of the liquid is used to form a beverage;
determining a remaining volume of the liquid in the liquid supply tank based on the initial volume and the first volume and without measuring a volume of the liquid in the liquid supply tank after the start of the beverage cycle;
comparing the remaining volume of the liquid in the liquid supply tank to a threshold volume; and
providing an indication that the remaining volume of the liquid in the liquid supply tank is lower than the threshold volume.

32-36. (canceled)

37. A beverage machine comprising:
a liquid supply tank configured to hold an initial volume of a liquid at a start of a beverage cycle during which a first volume of the liquid is used to form a beverage; and
a controller configured to determine a remaining volume of the liquid in the liquid supply tank based on the initial volume and the first volume and without measuring a volume of the liquid in the liquid supply tank after the start of the beverage cycle;
wherein the controller is configured to compare the remaining volume of the liquid in the liquid supply tank to the threshold volume and provide an indication that the remaining volume of the liquid in the liquid supply tank is lower than the threshold volume.

38. The beverage machine of claim 37, further comprising:
a conduit having an inlet fluidly coupled to the liquid supply tank, the conduit having a section containing a gas having a gas volume;
a pump fluidly coupled to an outlet of the conduit, wherein the pump is configured to pump liquid and gas;
a vent configured to vent a portion of the conduit to atmospheric pressure; and
a valve configured to selectively open and close the vent, wherein the controller is configured to selectively open and close the valve; and
wherein the controller is configured to determine the initial volume of the liquid at the start of the beverage cycle based on an operation time of the pump required to pump the gas volume from the conduit.
